(19) United States
(12) Patent Application Publication
(10) Pub. No.: US 2002/0118181 A1
(43) Pub. Date: Aug. 29, 2002

(54) Absolute optical position determination

(76) Inventor: Oral Sekendur, Chicago, IL (US)

Correspondence Address: ORAL SEKENDUR, 399 WEST FULLERTON PARKWAY, APARTMENT 15 WEST, CHICAGO, IL, 60614, US

(21) Appl. No.: 09/725,301

(22) Filed: Nov. 29, 2000

(51) Int. Cl. G09G 5/00

(52) U.S. Cl. 345/179

(57) ABSTRACT

The present invention is a form of a digitizer and absolute position determination device for indicating the instantaneous position and movement of a stylus on a surface. It proposes the use of at least three points of position-related information for indicating X-Y coordinates and a surface such as paper comprising two points of the three points of position-related information. The stylus or pen 2 in FIG. 1 comprising a writing element 6 and one of the three points of position-related information has a light source 16 illuminating the surface. A detector 3 comprising a charge-coupled device (CCD) located on the stylus detects the position-related information. The position-related information from the CCD is sent to a computer for processing and finally the desired information output to the user. Different frequency(s) of light can be used depending on the application. During the process of writing, position-related information is detected and sent to the computer for analysis, and finally output to the user. The position of the writing element is determined using the principals of triangulation. Through the use of handwriting recognition software, the output can be converted to a “keyboard-typed” representation of the handwritten text.

### FIELD OF THE INVENTION

This invention relates to apparatus and method for generating absolute position related computer data from obtaining and outputting the instantaneous position and/or movement of a moveable element on a data surface, such as might be used for determining the position and/or movement of a pen/pencil on paper. In addition, this invention will allow the user to input graphical information (e.g., drawings or handwriting) and simultaneously provide an original hard copy of the information.

### BACKGROUND-DESCRIPTION OF PRIOR ART

The following United State Patents are believed to be most closely related to the present invention:

U.S. Pat. Nos.:

| | | | | |
|---|---|---|---|---|
| 6,100,538 | 6,008,800 | 6,005,548 | 5,982,352 | 5,953,000 |
| 5,936,615 | 5,729,251 | 5,689,619 | 5,525,764 | 5,477,012 |
| 5,086,197 | 5,075,558 | 5,075,541 | 5,051,736 | 5,009,277 |
| 4,975,546 | 4,885,433 | 4,853,496 | 4,845,684 | 4,809,351 |
| 4,806,707 | 4,804,949 | 4,751,741 | 4,532,376 | 4,364,035 |
| 4,141,073 | | | | |

Many attempts have been made to determine the position of an object on a data surface in the form of computer data. Both two-dimensional and three-dimensional position determining devices now exist for inputting graphical data such as handwritten text, symbols, drawings, and so on. These devices determine the absolute position and/or movement of a stylus on a data surface by converting the position information into coordinates.

The use of a writing tablet and a stylus is common for inputting hand written data. Most two-dimensional devices require contact between the writing tablet and stylus. Three-dimensional devices usually do not require contact. They normally use a form of wave energy such as light, electromagnetic, or sonic energy.

Generally, two relationships exist between the stylus and the writing tablet. The passive stylus/active tablet utilizes a passive stylus interfacing with an active receiving surface (e.g., resistive and capacitive methods), while the active stylus/passive tablet utilizes an active stylus interfacing with a passive surface (e.g., optical, acoustic, tactile, or electromagnetic). A third method using a mechanical linkage such as a pantograph is rarely used.

The passive stylus/active surface method has some significant shortcomings. The most significant is the active surface or tablet itself Besides being complex, large, heavy, cumbersome and difficult to transport, the tablet is expensive. Further, the tablet cannot usually distinguish between the stylus and another object pressing on it. Still further, active tablets are difficult to manufacture, subject to interference from outside factors, and have complex mechanical and electrical parts that are subject to malfunction.

The active stylus/passive surface method also has major drawbacks. Most significantly, this method generally requires an awkward tablet besides a separate transmitter and receiver (usually in different locations). Further, the transmitted signal can become obscured before reaching the receiver.

Another class of active stylus/passive surface devices provides relative position information. An example is the computer mouse that includes the mechanical mouse comprising a ball rolling on a surface, and the optical mouse comprising a surface with grid lines and an optical input means within the mouse.

Most recently, active stylus/passive surface methods comprise a form of transducer, gyroscope and/or accelerometer located in the stylus itself.

Both the passive stylus/active surface and active stylus/passive surface methods have the feeling of being unnatural and require a significant interface adjustment for the user from the conventional pen/pencil and paper. The amount and accuracy of information provided by these methods are limited. In addition, some of these methods require a physical connection between the stylus and the tablet. All the methods provide two-dimensional information. Some provide three-dimensional information. Further, they may provide one or more, but not all the following information: displacement, rotation, angle to tablet, and velocity. None provide all of this information.

A significant advantage of the present invention is its interface. Overall, no matter how good a computer interface is, less of it would be better. The present invention allows for an interface that is almost identical to that of a pen/pencil and paper. The present invention is used in the same manner as a pen/pencil and paper and all of the computing is done in the background unnoticed by the user. The present invention turns an ordinary pen/pencil and paper into a powerful computer. The pen/pencil and paper are familiar and comfortable interfaces to the user. If the user is comfortable with the pen/pencil and paper then the user will be very comfortable with the present invention.

As part of output, the aforementioned methods can provide a printed hard copy, but they do not provide an original hard copy as part of the input. In the present invention, the information is input, analyzed, then output. Since the present invention teaches obtaining coordinate information by scanning a surface and simultaneously placing information on the surface by writing on the surface with a stylus, an original hard copy is produced as part of the input by writing or drawing on the surface.

This inventor has patented a device (U.S. Patent No. 5,477,012) comprising a passive coded surface and an active stylus comprising a video camera. The drawback to this system is the requirement of the passive coded surface. The present invention overcomes this drawback by eliminating the need for the passive coded surface. Now, any surface can be used. For example, paper and stylus in the present invention will most closely simulate the familiar use of ordinary pen/pencil and paper.

### OBJECTS AND ADVANTAGES

It is an object of the present invention to provide all of the aforementioned information.

It is an object of the present invention to overcome all of the aforementioned disadvantages.

It is an object of the present invention to provide an apparatus and method for obtaining and outputting the absolute position and/or movement of a moveable element on a surface.

It is an object of the present invention to provide an apparatus and method for obtaining and outputting the absolute position and/or movement of a moveable element on a surface for acquisition and output of hand written data.

It is an object of the present invention to provide a system that most closely resembles using pen/pencil and paper.

It is an object of the present invention to provide an original hard copy of data as part of the input process of writing on a surface.

It is an object of the present invention to provide an apparatus and method of the character described in which the absolute position and/or movement of the movable element can be precisely determined relative to at least one fixed reference.

It is an object of the present invention to provide an apparatus and method of the character described in which the absolute position and/or movement of the movable element can be precisely determined relative to at least one fixed reference where the at least one fixed reference is automatically detected.

It is an object of the present invention to provide an apparatus for hand held use.

It is an object of the present invention to provide the aforementioned movable element in the shape of a stylus.

It is an object of the present invention to provide an apparatus of the character described which does not require the use of a special digitizing tablet.

It is an object of the present invention to provide an apparatus of the character described which does not require the use of a special surface.

It is an object of the present invention to provide an apparatus of the character described which does not require the use of a special transmitter.

It is an object of the present invention to provide an apparatus of the character described which can use a writing surface such as ordinary paper.

It is an object of the present invention to provide an apparatus and method for obtaining and outputting the position and/or movement of a moveable element on a surface comprising the surface, a detector means, a data processing means and a data output means.

It is an object of the present invention to provide an apparatus and method for precisely locating the absolute position and/or movement of a movable element within a plane. More particularly, it is an object of the invention to provide an input/output apparatus for use with a computer that includes a movable element, whose absolute position and/or movement within a plane can be determined with or without a physical connection between the movable element and the plane.

It is an object of the present invention to provide an apparatus and method for handwriting recognition.

It is an object of the present invention to provide an apparatus and method for optical character recognition (OCR).

It is an object of the present invention to provide an apparatus and method for signature verification.

It is an object of the present invention to provide an apparatus and method for handwriting verification.

It is an object of the present invention to provide an apparatus and method for finger print recognition.

It is an object of the present invention to provide an apparatus and method for graphical recognition.

It is an object of the present invention to provide an apparatus and method for graphical input.

It is an object of the present invention to provide an apparatus and method for forms processing.

It is an object of the present invention to provide an apparatus and method for converting optically input data into coordinate data.

It is an object of the present invention to provide an apparatus and method for applying position related information to a surface.

It is an object of the present invention to provide an apparatus and method for applying position related information to a surface with by writing on it while scanning, then using the written information for position determination.

It is an object of the present invention to provide an apparatus and method for applying position related information to a surface by writing the surface while scanning, then using the written data as points of reference.

It is an object of the present invention to provide an apparatus and method for providing analog data.

It is an object of the present invention to provide an apparatus and method for providing digital data.

It is an object of the present invention to provide an apparatus and method for digitizing optical data.

It is an object of the present invention to provide an apparatus and method for learning a surface.

It is an object of the present invention to provide a writing surface made of a material selected from the group consisting of paper, plastic, glass, metal, synthetic fiber, synthetic material, natural material, and a paper like substance.

### DESCRIPTION OF DRAWINGS

FIG. 1 is a perspective view of an embodiment using a pen, paper, CCD camera and a computer.

Reference Numerals in Drawings

| | | | |
|---|---|---|---|
| 1 | writing surface | 2 | pen |
| 3 | CCD camera | 4 | wireless interface |
| 5a | left corner | 5b | right corner |
| 6 | writing means | 7 | adaptor |
| 8 | universal joint | 9 | computer |
| 10 | clipboard | 11a | left clipboard reference point |
| 11b | right clipboard reference point | 12a | left external reference point |
| 12b | right external reference point | 13 | microcomputer |
| 14 | display | 15 | function keys |
| 16 | illumination | | |

### DESCRIPTION OF PREFERRED EMBODIMENTS

The present invention aims to overcome the aforementioned disadvantages and to provide a system that most closely emulates the use of pen/pencil and paper.

Accordingly, the present invention proposes the use of a writing surface such as paper, a stylus, and a charge-coupled device (CCD). An output signal from the CCD or array of light sensitive elements is sent to a computer or processor and finally output to the user. The output can be in various forms including an image on a computer display or a computer printout.

The instantaneous position of the stylus relative to the writing surface is determined using the principal of triangulation. The CCD camera automatically detects at least two fixed reference points, such as the corners of the writing surface, and triangulates them with a writing element on the stylus to determine the instantaneous position of the writing element. Alternatively, the user, using the writing element on the stylus can apply to the writing surface the reference points visible to the CCD camera. Still further, at least two fixed reference points can be pre-applied to the writing surface.

The reference points are dynamic, in that, the CCD camera will select two fixed reference points based on a set of pre-determined criteria. The two fixed reference points need only to be fixed instantaneously since the CCD camera is able to dynamically and instantaneously select a different set of two fixed reference points.

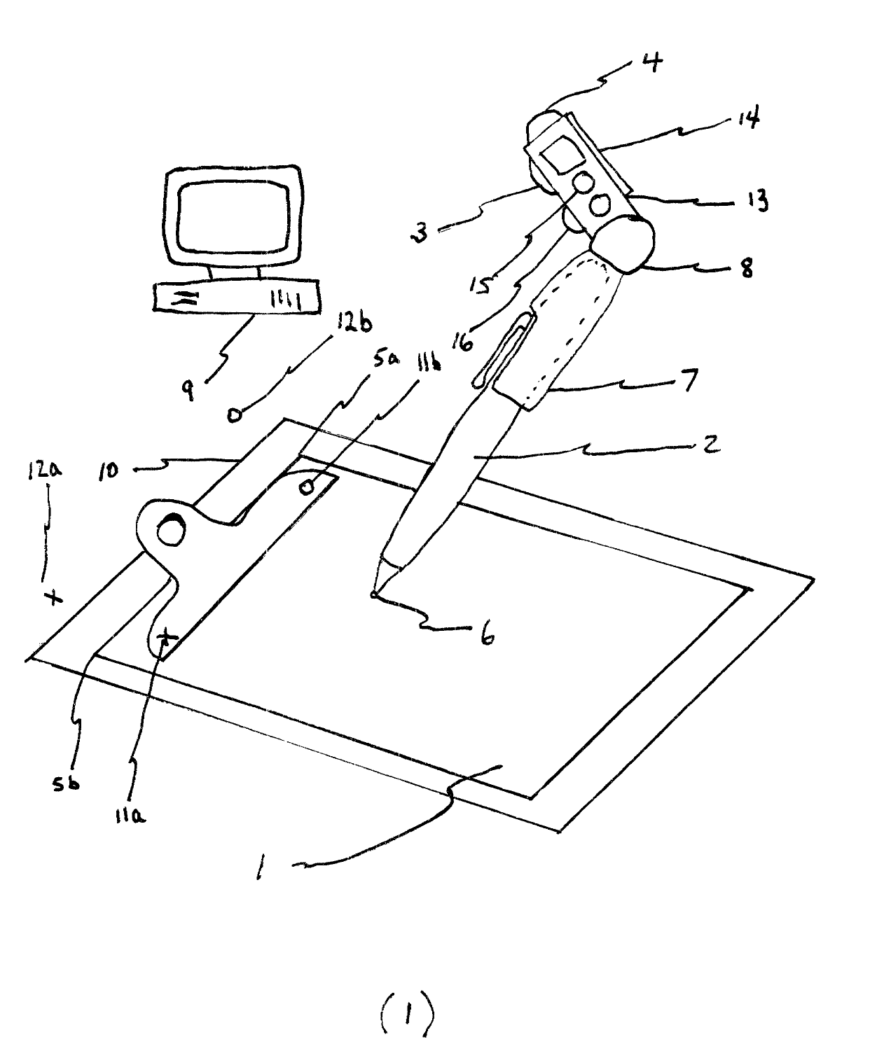

One embodiment comprises a writing surface 1 in FIG. 1, a pen 2, a CCD camera 3 and a wireless interface 4. The CCD camera detects two fixed reference points based on a set of pre-determined criteria such as comers 5a and 5b of the writing surface and triangulates the instantaneous position of the writing element 6 of the pen. The two fixed reference points are dynamic, in that, the CCD camera will detect any two points which may include the corners of the writing surface or any other marks in its field of vision. The other marks may include pre-applied marks on the surface or marks instantly applied using the writing element. The CCD camera may dynamically change the two fixed reference points it selects based on a set of predetermined criteria.

The CCD camera is mounted on the pen using an adaptor 7 that fits securely on the upper end of the pen. This position allows the CCD camera to view the writing surface, the writing element and the two fixed reference points. Should the reference points become obscured from the field of view, the CCD camera will select other points of reference. A universal joint 8 allows maximum mobility for the CCD camera. Finally, position related information is sent by a wireless interface to a computer 9 for processing.

Further, a clip board 10 can be provided comprising the two fixed reference points, such as the left clip board reference point 11a and the right clip board reference point 11b. Still further, the two fixed reference points can be provided external to the writing surface or the clip board, such as the left external reference point 12a and the right external reference point 12b. A microprocessor 13 and a display 14 can be provided. Function keys 15 and illumination means 16 can also be provided.

The least three points of coordinate-related information can be made to selectively reflect at least one selected frequency of light, and the detector means can be made to selectively detect at least one selected frequency of light.

While writing on the writing surface, the two fixed reference points are detected relative to the writing element, input, and analyzed. Thus, the instantaneous position and movement of the writing element is determined.

Other embodiments include an overlay such as carbon paper, film template or plate for overlaying the surface with position related data, a pressure switch for turning on the CCD camera when pressure is applied to the writing element and a focusing method for focusing the surface.

Other techniques could be used to determine the position of the writing element. For example, mirrors mounted at angles to detect the position of the writing element using triangulation techniques can be used. Additionally, two cameras can be used to capture different views of the writing surface and the frames of the two cameras can be calibrated and compared with each other to determine movement and position of the writing element. Other optical techniques are grid and moire triangulation.

The above-described embodiments are simply illustrative of the principles of the invention. Various other modifications and changes may be made by those skilled in the art which will embody the principles of the invention and fall within the spirit and scope thereof

I claim:

1. An apparatus for obtaining and outputting the position and movement of a moveable element on a surface comprising:
at least three points of position related data;
a data input means for obtaining said at least three points of position related data;
a data output means for outputting said at least three points of position related data;
a data processing means for obtaining and analyzing said at least three points of position related data from said data output means;
said at least three points of position related data comprising at least two fixed points of position related data and at least one movable point of position related data;
whereby said movable element comprises said at least one movable point of position related data;
whereby said at least three points of position related data are triangulated to obtain the position and movement of said moveable element.

2. An apparatus according to claim 1 wherein:
said surface comprises a writing surface;
said movable element comprises a writing means for writing on said surface.

3. An apparatus according to claim 1 wherein:
said surface comprises a substantially two dimensional planar face and further comprises said at least two fixed points of position-related data;
said data input means is a detector means comprising an array of light sensitive elements for detecting said at least three points of position related data and an output means for generating at least one output signal thereof;
said processing mean's comprises means for receiving and processing said at least one output signal form said detector means, thereby to determine the position and movement of said movable element relative to said surface.

4. An apparatus according to claim 3 wherein:
said moveable element comprises said detector means, whereby said movable element is movable relative to said surface;
means for determining the path of said moveable element are provided by detecting a sequence of said position-related data.
means for analyzing the path of said moveable element are provided.

5. An apparatus according to claim I selected from the group consisting of
said at least three points of position-related data comprising position-related data for a plurality of points out said surface;
said apparatus whereby said at least two fixed points of position related data are printed on said surface;
said apparatus whereby said at least two fixed points of position related data are written on said surface;
said apparatus whereby said at least two fixed points of position related data comprise existing features on said surface;
said apparatus whereby said at least two fixed points of position related data comprise existing features obtainable by said data input means;
said apparatus whereby said at least two fixed points of position related data comprise points outside the parameters of said surface;
said apparatus whereby said surface comprises a writing surface and said movable element comprises a writing means for writing on said surface and whereby said writing means comprises said at least one movable point of position related data.

6. An apparatus according to claim 1 selected from the group consisting of:
said apparatus designed for use with computer;
said apparatus comprising a computer display;
said apparatus comprising a computer printer,
said apparatus comprising a computer;
said apparatus comprising a CCD camera;
said apparatus comprising writing means for writing on said surface;
said apparatus comprising a microcomputer;
said apparatus comprising a display;
said apparatus comprising function keys;
said apparatus comprising an illumination means;
said apparatus whereby said processing means comprises a computer;
said apparatus whereby said surface comprises a writing surface;
said apparatus comprising a writing means for writing on said surface and further comprises an original hard copy means for forming an original hard copy made by said writing means on said surface;
said apparatus whereby said surface is made of a material selected from the group consisting of paper, plastic, glass, metal, synthetic fiber, synthetic material, natural material, and a paper like substance,
said apparatus whereby said at least three points of position-related data comprise a reflecting means for reflecting said at least three points of position-related data to said data input means,
said apparatus whereby said moveable element is selected from the group consisting of a stylus shaped moveable element for hand held use, and a hand held moveable element,
said apparatus whereby said surface comprises an overlay means for overlaying said surface with said overlay means comprising said at least two fixed points of position related data selected from the group consisting of carbon paper, film template and plate,
said apparatus whereby said surface comprises an overlay means for overlaying said surface with said at least two fixed points of position related data;
said apparatus whereby said data processing means uses the principle triangulation to determine the position of said moveable element relative to said surface,
said apparatus whereby said at least three points of position-related data comprise a selective reflecting means for selectively reflecting at least one selected frequency of light,
said apparatus whereby said data input means comprises a selective input means far selectively inputting at least one selected frequency of light,
said apparatus comprising a pressure switch means for turning on said apparatus when pressure is applied to said movable element,
said apparatus including a focusing means for focusing said surface,
said movable element comprising a writing means for writing on said surface,
said movable element comprising a self contained optical stylus, a writing means for writing on said surface, said input means for inputting said at least three points of position related data, said output means for outputting said at least three points of position related data, a microcomputer, a user interface means for communicating with a user and a device interface means for communicating with other devices,
said apparatus whereby said input means is selected from the group consisting of:
said input means mounted on said movable element;
said input means mounted on a computer monitor;
said input means mounted on a portable computer;
said input means mounted to input said at least three points of position-related data.

7. A method of producing an electronic duplicate of markings made upon a surface wherein there is provided:
a position related means for designating the position of at least one point on said surface;
a movable element;
a detector means for detecting said position related means and for generating at least one output signal thereof;
a processing means for receiving and processing said at least one output signal, thereby to determine the position of said movable element relative to said surface;
whereby said position related means are triangulated to obtain the position and movement of said movable element.

8. A method of producing an electronic duplicate of markings made upon a surface according to claim 7 wherein there is provided:
a movable element comprising a writing means for writing on said surface;
said surface comprising a writing surface.

9. A method of producing an electronic duplicate of markings made upon a surface according to claim 7 wherein there is provided:
at least three points of position related data;
said at least three points of position related data comprising at least two fixed points of position related data and at least one movable point of position related data;
said surface comprises a substantially two dimensional planar face and further comprises said at least two fixed points of position-related data;
said movable element comprising said at least one movable point of position related data;
said detector means comprising an array of light sensitive elements for detecting said at least three points of position related data and an output means for generating at least one output signal thereof,
said processing mean's comprises means for receiving and processing said at least one output signal form said output means, thereby to determine the position and movement of said movable element relative to said surface;
whereby said at least three points of position related data are triangulated to obtain the position and movement of said moveable element.

10. A method of producing an electronic duplicate of markings made upon a surface according to claim 9 wherein there is provided:
said moveable element comprises said detector means, whereby said movable element is movable relative to said surface;
means for determining the path of said moveable element are provided by detecting a sequence of said position-related data.
means for analyzing the path of said moveable element are provided.

11. A method of producing an electronic duplicate of markings made upon a surface according to claim 9 wherein there is provided:
said at least three points of position-related data comprising position-related data for a plurality of points out said surface;
said at least two fixed points of position related data are printed on said surface;
said at least two fixed points of position related data are written on said surface;
said at least two fixed points of position related data comprise existing features on said surface;
said at least two fixed points of position related data comprise existing features obtainable by said data input means;
said at least two fixed points of position related data comprise points outside the parameters of said surface;
said surface comprises a writing surface and said movable element comprises a writing means for writing on said surface and whereby said writing means comprises said at least one movable point of position related data.

12. A method of producing an electronic duplicate of markings made upon a surface according to claim 9:
designed for use with computer;
comprising a computer display;
comprising a computer printer,
comprising a computer;
comprising a CCD camera;
comprising writing means for writing on said surface;
comprising a microcomputer;
comprising a display;
comprising function keys;
comprising an illumination means,
whereby said processing means comprises a computer;
whereby said surface comprises a writing surface;
comprising a writing means for writing on said surface and further comprises an original hard copy means for forming an original hard copy made by said writing means on said surface;
whereby said surface is made of a material selected from the group consisting of paper, plastic, glass, metal, synthetic fiber, synthetic material, natural material, and a paper like substance,
whereby said at least three points of position-related data comprise a reflecting means for reflecting said at least three points of position-related data to said data input means,
whereby said moveable element is selected from the group consisting of a stylus shaped moveable element for hand held use, and a hand held moveable element,
whereby said surface comprises an overlay means for overlaying said surface with said overlay means comprising said at least two fixed points of position related data selected from the group consisting of carbon paper, film template and plate,
whereby said surface comprises an overlay means for overlaying said surface with said at least two fixed points of position related data;
whereby said data processing means uses the principle triangulation to determine the position of said moveable element relative to said surface,
whereby said at least three points of position-related data comprise a selective reflecting means for selectively reflecting at least one selected frequency of light,
whereby said data input means comprises a selective input means far selectively inputting at least one selected frequency of light,
comprising a pressure switch means for turning on said apparatus when pressure is applied to said movable element,
including a focusing means for focusing said surface,
said movable element comprising a writing means for writing on said surface,
said movable element comprising a self contained optical stylus, a writing means for writing on said surface, said input means for inputting said at least three points of position related data, said output means for outputting said at least three points of position related data, a microcomputer, a user interface means for communicating with a user and a device interface means for communicating with other devices,
whereby said input means is selected from the group consisting of:
said input means mounted on said movable element;
said input means mounted on a computer monitor;
said input means mounted on a portable computer;
said input means mounted to input said at least three points of position-related data.
whereby said surface is adapted to function as writing surface;
said detector means comprises a writing means for marking said writing surface visibly as said detector means and said writing mean move together relative to said surface; and
whereby said processing means is adapted to produce a digital duplicate of visible marks made on said writing surface.

13. An apparatus comprising coordinate sensor means and processing means further comprising:
a position related means for designating the position of at least one point on said surface;
a movable element;
a detector means for detecting said position related means and for generating at least one output signal thereof,
a processing means for receiving and processing said at least one output signal, thereby to determine the position of said movable element relative to said surface;
whereby said position related means are triangulated to obtain the position and movement of said movable element.

14. An apparatus according to claim 13 wherein there is provided:
a movable element comprising a writing means for writing on said surface;
said surface comprising a writing surface.

15. An apparatus according to claim 13 wherein there is provided:
at least three points of position related data;
said at least three points of position related data comprising at least two fixed points of position related data and at least one movable point of position related data;
said surface comprises a substantially two dimensional planar face and further comprises said at least two fixed points of position-related data;
said movable element comprising said at least one movable point of position related data;
said detector means comprising an array of light sensitive elements for detecting said at least three points of position related data and an output means for generating at least one output signal thereof;
said processing mean's comprises means for receiving and processing said at least one output signal form said output means, thereby to determine the position and movement of said movable element relative to said surface;
whereby said at least three points of position related data are triangulated to obtain the position and movement of said moveable element.

16. An apparatus according to claim 15 wherein there is provided:
said moveable element comprises said detector means, whereby said movable element is movable relative to said surface;
means for determining the path of said moveable element are provided by detecting a sequence of said position-related data.
means for analyzing the path of said moveable element are provided.

17. An apparatus according to claim 15 wherein there is provided:
said at least three points of position-related data comprising position-related data for a plurality of points out said surface;
said at least two fixed points of position related data are printed on said surface;
said at least two fixed points of position related data are written on said surface;
said at least two fixed points of position related data comprise existing features on said surface;
said at least two fixed points of position related data comprise existing features obtainable by said data input means;
said at least two fixed points of position related data comprise points outside the parameters of said surface;
said surface comprises a writing surface and said movable element comprises a writing means for writing on said surface and whereby said writing means comprises said at least one movable point of position related data.

18. A method of producing an electronic duplicate of markings made upon a surface according to claim 15:
designed for use with computer;
comprising a computer display;
comprising a computer printer,
comprising a computer;
comprising a CCD camera;
comprising writing means for writing on said surface;
comprising a microcomputer;
comprising a display;
comprising function keys;
comprising an illumination means;
whereby said processing means comprises a computer;
whereby said surface comprises a writing surface;
comprising a writing means for writing on said surface and further comprises an original hard copy means for forming an original hard copy made by said writing means on said surface;
whereby said surface is made of a material selected from the group consisting of paper, plastic, glass, metal, synthetic fiber, synthetic material, natural material, and a paper like substance,
whereby said at least three points of position-related data comprise a reflecting means for reflecting said at least three points of position-related data to said data input means,
whereby said moveable element is selected from the group consisting of a stylus shaped moveable element for hand held use, and a hand held moveable element,
whereby said surface comprises an overlay means for overlaying said surface with said overlay means comprising said at least two fixed points of position related data selected from the group consisting of carbon paper, film template and plate,
hereby said surface comprises an overlay means for overlaying said surface with said at least two fixed points of position related data;
whereby said data processing means uses the principle triangulation to determine the position of said moveable element relative to said surface,
whereby said at least three points of position-related data comprise a selective reflecting means for selectively reflecting at least one selected frequency of light,
whereby said data input means comprises a selective input means far selectively inputting at least one selected frequency of light,
comprising a pressure switch means for turning on said apparatus when pressure is applied to said movable element,
including a focusing means for focusing said surface,
said movable element comprising a writing means for writing on said surface,
said movable element comprising a self contained optical stylus, a writing means for writing on said surface, said input means for inputting said at least three points of position related data, said output means for outputting said at least three points of position related data, a microcomputer, a user interface means for communicating with a user and a device interface means for communicating with other devices,
whereby said input means is selected from the group consisting of:
said input means mounted on said movable element;
said input means mounted on a computer monitor;
said input means mounted on a portable computer;
said input means mounted to input said at least three points of position-related data.
whereby said surface is adapted to function as writing surface;
said detector means comprises a writing means for marking said writing surface visibly as said detector means and said writing mean move together relative to said surface, and
whereby said processing means is adapted to produce a digital duplicate of visible marks made on said writing surface.
